(19) United States
(12) Patent Application Publication
(10) Pub. No.: US 2011/0246376 A1
(43) Pub. Date: Oct. 6, 2011

(54) COST BENEFIT BASED ANALYSIS SYSTEM FOR NETWORK ENVIRONMENTS

(75) Inventors: Murthy V. Devarakonda, Peekskill, NY (US); Vijay K. Naik, Pleasantville, NY (US)

(73) Assignee: International Business Machines Corporation, Armonk, NY (US)

(21) Appl. No.: 12/751,271

(22) Filed: Mar. 31, 2010

(51) Int. Cl. G06Q 10/00; G06F 15/173; G06Q 50/00

(52) U.S. Cl. 705/301; 705/348; 709/224

(57) ABSTRACT

A method, apparatus, and computer program product for planning changes to network data processing systems. A number of processes performed in a current network data processing system and labor used to perform the number processes are identified. Resources in the current network data processing system used by the number of processes are identified. A first cost for labor used to perform the number of processes using the current network data processing system is calculated. A second cost for the resources in the current network data processing system is calculated. A first change in the first cost for labor in a new network data processing system based on a number of changes to the number of processes when the number of processes is performed in the new network data processing system is identified. A second change in the second cost for the resources in the new network data processing system is identified.

### BACKGROUND OF THE INVENTION

1. Field of the Invention

The present invention relates generally to data processing systems and, more specifically, to network data processing systems. Still more particularly, the present disclosure relates to a method and apparatus for planning changes to a network environment.

2. Description of the Related Art

Network data processing systems are used for a variety of different purposes. For example, network data processing systems are used by organizations to perform various processes. These processes include, for example, business and information processing processes. Network data processing systems are also used by users to obtain and search for information, communicate with others, purchase goods and services, and for other types of uses.

Network data processing systems come in a number of different forms. For example, the Internet is a global network of computers and networks joined together by gateways that handle data transfer and conversion of messages. The Internet is used to provide access to information, as well as transact business. Additionally, other types of network data processing systems are commonly used by organizations. These network data processing systems may include, for example, without limitation, local area networks, wide area networks, clouds, virtual private networks, and other suitable types of networks.

With clouds, the users of this type of network data processing system neither own nor manage the physical infrastructure. In this manner, users may avoid capital expenditures, support costs, maintenance costs, labor costs, and other costs associated with more traditional types of networks. With cloud-based network environments, users consume resources as a service and typically pay based on the use of those resources. With clouds, capital expenditures, such as costs for hardware, software, information technology services, and other associated costs, may be avoided.

Different types of clouds are present that may be selected by different users. Clouds may include, for example, a public cloud, a private cloud, and a hybrid cloud. A public cloud is a network environment in which users access resources over a network, such as the Internet. A private cloud is an internal cloud in which resources are accessed on private networks, such as an intranet. A private cloud also may provide additional separation from other users. A private cloud may include firewalls and other devices to provide for increased security and separation. These types of clouds may offer increased data security and reliability concerns as compared to a public cloud accessed over the Internet. A hybrid cloud may include resources accessed through a publicly accessed network and an internal or private network.

Organizations that employ network data processing systems may make changes to their network data processing systems. These changes may include choosing to retain and upgrading hardware and software in the current network data processing system or change to a new type of network data processing system. One incentive for moving over to a new network environment is a reduction in costs to the organization in performing its processes.

For example, an organization may contemplate whether to change over from a more traditional network environment to a cloud network environment. In addition to whether to use a cloud network environment, an organization may need to determine whether to use a public cloud, a private cloud, or a hybrid cloud. Each type of these clouds has different types of features, benefits, constraints, and costs.

As another example, an organization that currently uses a private cloud environment may make a determination as to whether a public or a hybrid cloud environment may be more beneficial. A hybrid cloud is a combination of both a private cloud and a public cloud. These types of decisions are often made with the use of consultants to provide help and guidance.

### BRIEF SUMMARY OF THE INVENTION

A method, apparatus, and computer program product for planning changes to network data processing systems. A number of processes performed in a current network data processing system and labor used to perform the number processes are identified. Resources in the current network data processing system used by the number of processes are identified. A first cost for labor used to perform the number of processes using the current network data processing system is calculated. A second cost for the resources in the current network data processing system is calculated. A first change in the first cost for labor in a new network data processing system based on a number of changes to the number of processes when the number of processes is performed in the new network data processing system is identified. A second change in the second cost for the resources in the new network data processing system is identified.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is an illustration of a network analysis environment in accordance with an illustrative embodiment;

FIG. 4 is a diagram of labor used to perform processes in a network data processing system in accordance with an illustrative embodiment;

FIG. 5 is an illustration of a process performed using a current network data processing system in accordance with an illustrative embodiment;

FIG. 6 is an illustration of a process performed using a new network data processing system in accordance with an illustrative embodiment;

FIG. 7 is a flowchart of a process for planning changes to network data processing systems in accordance with an illustrative embodiment; and

FIG. 8 is an illustration of cost estimation in accordance with an illustrative embodiment.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CDROM), an optical storage device, a transmission media, such as those supporting the Internet or an intranet, or a magnetic storage device. Note that the computer usable or computer readable medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction system, apparatus, or device. The computer usable medium may include a propagated data signal with the computer usable program code embodied therewith, either in baseband or as part of a carrier wave. The computer usable program code may be transmitted using any appropriate medium, including, but not limited to, wireless, wireline, optical fiber cable, RF, etc.

Computer program code for carrying out operations of the present invention may be written in any combination of one or more programming languages, including an object-oriented programming language, such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams and combinations of blocks in the flowchart illustrations and/or block diagrams can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

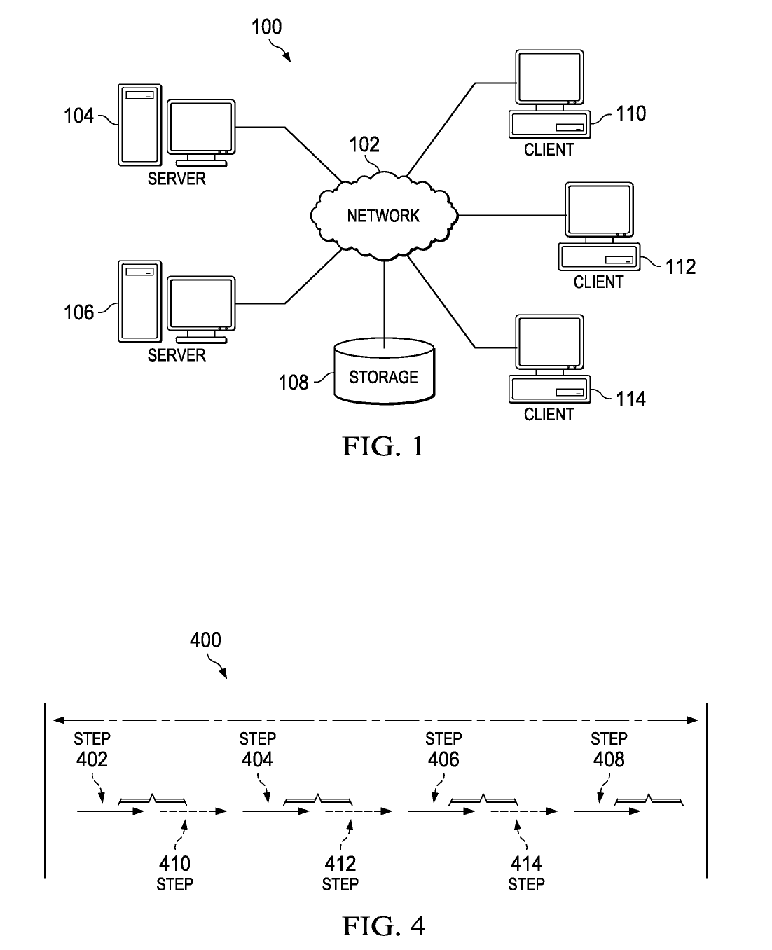

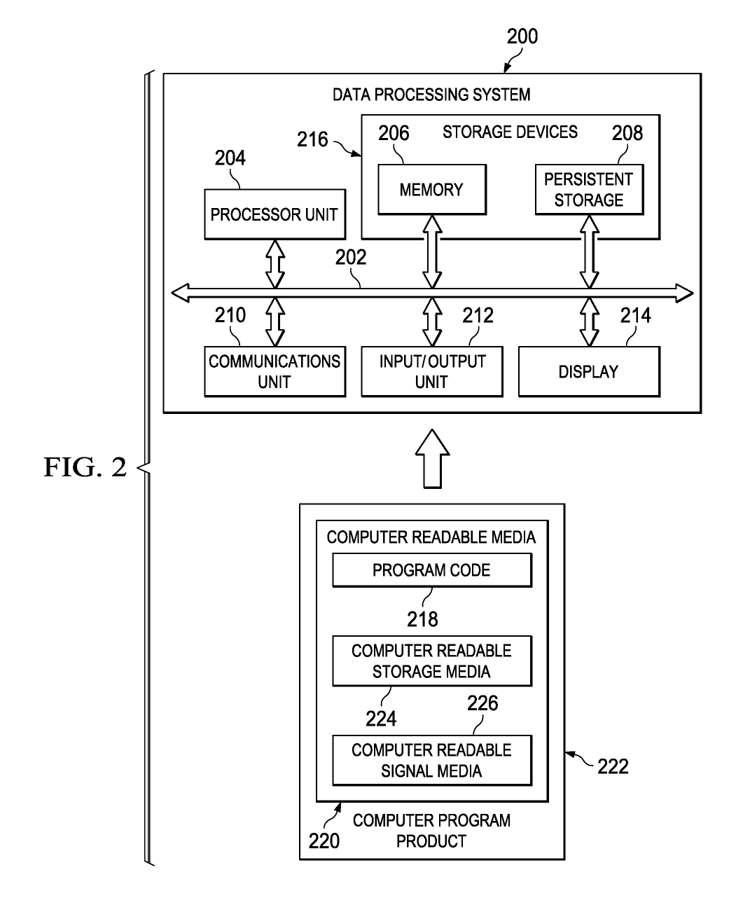

With reference now to the figures and, in particular, with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example and not as an architectural limitation for the different illustrative embodiments.

With reference now to FIG. 2, a block diagram of a data processing system is shown in which illustrative embodiments may be implemented. Data processing system 200 is an example of a computer, such as server computer 104 or client computer 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 or run by processor unit 204. The processes of the different embodiments may be performed by processor unit 204 using computer implemented instructions, which may be located in a memory, such as memory 206.

These instructions are referred to as program code, computer usable program code, or computer readable program code that may be read and run by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 and run by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The different illustrative embodiments recognize and take into account a number of different considerations. In these examples, “a number”, when used with reference to items, means one or more items. For example, a number of different considerations is one or more different considerations.

The different illustrative embodiments recognize and take into account that currently available systems for analyzing network data processing systems take into account the cost of resources within the network data processing systems. In other words, the cost of computers, information technology personnel, system administrators, hardware, software, and other resources within a network data processing system are analyzed. The current analysis identifies the difference in costs between a current network data processing system and a new network data processing system. Although these types of analysis may identify changes in the cost or resources, this type of analysis may not provide an accurate analysis of the overall effect on the costs incurred by an organization in performing its processes.

For example, the different illustrative embodiments recognize and take into account that changing from one network data processing system to another network data processing system may not change the cost of resources sufficiently to warrant a change. These types of analyses, however, do not take into account the effects on the labor involved in performing processes within the organization that may change in a manner that reduces the total costs as a result of the change in the network data processing environment. Thus, although the cost of resources may not change enough to warrant a change in network environments, the change in labor to perform the processes in the second network data processing systems may be great enough to justify the change.

Thus, the illustrative embodiments provide a method for planning changes to network data processing systems. In some illustrative embodiments, a number of processes performed in a current network data processing system and the labor used to perform the number of processes are identified. The resources in the current network data processing system used by the number of processes are also identified. The first cost for labor used to perform the number of processes using the current network data processing system is calculated. The second cost for the resources in the current network data processing system also is calculated. A change in first cost for labor in a new network data processing system is identified based on a number of changes to the number of processes when the number of processes is performed in the new network data processing system. A change in the second cost for the resources in the new network data processing system also is identified.

In one or more of the different illustrative embodiments, these changes are used to determine whether changing from the current network data processing system to the new network data processing system provides desired costs benefits. As a result, the different illustrative embodiments take into account changes in the cost for performing the number of processes in addition to changes in the cost for the resources when changing from one network data processing system to another network data processing system.

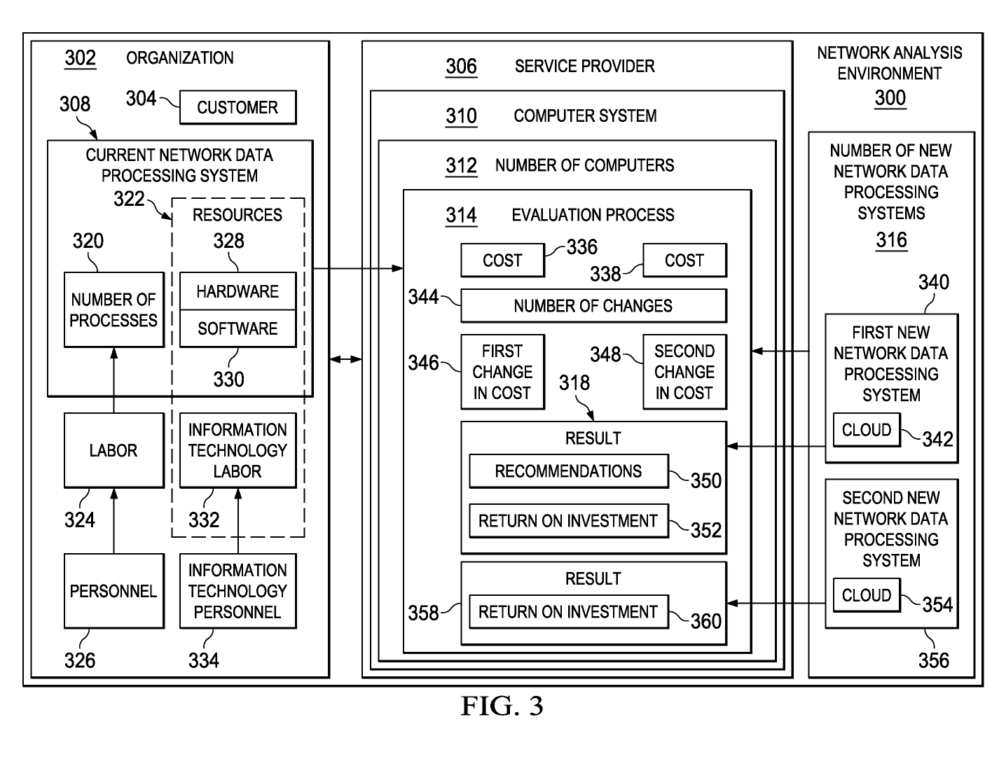

With reference now to FIG. 3, an illustration of a network analysis environment is depicted in accordance with an illustrative embodiment. Network analysis environment 300 may be used to plan changes to a network data processing system, such as network data processing system 100 in FIG. 1. Planning changes involves analyzing possible changes to the network data processing system and/or selecting at least one of the possible changes to the network data processing system.

In this depicted example, organization 302 may be customer 304 to service provider 306. For example, service provider 306 provides consultant services to organization 302 with respect to current network data processing system 308 used by organization 302. Organization 302 may be, for example, without limitation, a business, a corporation, or some other suitable type of organization. In this illustrative example, current network data processing system 308 is the network data processing system that is currently in use by organization 302.

In this depicted example, service provider 306 provides consultant services using computer system 310. Computer system 310 takes the form of number of computers 312 that may be in communication with each other. Number of computers 312 is implemented using a computer, such as data processing system 200 in FIG. 2.

Evaluation process 314 runs on computer system 310 in these examples. Evaluation process 314 compares number of new network data processing systems 316 to current network data processing system 308. Number of new network data processing systems 316 may be network data processing systems having different architectures from current network data processing system 308.

In these illustrative examples, evaluation process 314 analyzes current network data processing system 308 and number of new network data processing systems 316. The result of this analysis is result 318. Result 318 is used to generate recommendations for organization 302 with regard to possible changes to current network data processing system 308. Result 318 also includes the effects on costs for organization 302 and the possible benefits of changes to current network data processing system 308.

In these illustrative examples, number of processes 320 performed by organization 302 is identified. Number of processes 320 is processes performed using current network data processing system 308. Further, number of processes 320 may be one or more business and/or information technology processes and/or tasks for performing specific functions. Number of processes 320 may have defined start and end states in these examples.

Number of processes 320 may take a number of different forms. For example, without limitation, number of processes 320 may include at least one of online banking services, consultant services, tracking processes for package delivery, software development processes, web design processes, supply chain processes, manufacturing processes, and/or other suitable types of processes that may employ the use of a network data processing system.

Evaluation process 314 is used to identify number of processes 320 and resources 322. This identification may be made in a number of different ways. For example, without limitation, the information may be received as a result of interviews with organization 302. Additionally, this information may be obtained by service provider 306 analyzing current network data processing system 308.

In these illustrative examples, labor 324 is identified for number of processes 320. Labor 324 is performed by personnel 326 to perform number of processes 320.

Resources 322 include hardware 328 and software 330 in current network data processing system 308. Additionally, resources 322 also include information technology labor 332 performed by information technology personnel 334. Information technology labor 332 is labor used to provide the services of hardware 328 and software 330 to personnel 326 to perform number of processes 320 in current network data processing system 308. In other words, information technology labor 332 allows hardware 328 and software 330 to be used by personnel 326 to perform number of processes 320. In these illustrative examples, information technology labor 332 may include, for example, without limitation, provisioning servers, installing software programs, performing maintenance on computers, upgrading computers, and other suitable types of labor used to provide resources 322 to personnel 326.

In these illustrative examples, evaluation process 314 calculates cost 336 for performing number of processes 320. For example, cost 336 may be a cost of labor 324 used to perform number of processes 320. Cost 336 is calculated for labor 324 used to perform number of processes 320 within current network data processing system 308. Cost 336 may include a number of different types of costs for labor 324. Cost 336 may include, for example, without limitation, salaries paid to personnel. Additionally, cost 336 for labor 324 also may be calculated as the cost for a certain productivity of personnel 326 performing number of processes 320.

For example, if the payroll is fixed at one amount and the amount of goods or services produced is reduced when moving from one type of network to another type of network, cost 336 increases. If the amount of goods and services produced can be increased for the same amount of labor, cost 336 decreases. In these examples, cost 336 is an overall cost. In other words, the increase or decrease in cost 336 may be a result of increases and/or decreases in the different costs associated with labor 324 that make up cost 336. One manner in which the productivity may increase is a reduction in the amount of time needed to perform a task or a project. As a result, when productivity increases, more projects may be performed within the same amount of time. This increase in productivity reduces cost 336 for labor 324 in these examples.

Additionally, evaluation process 314 calculates cost 338 for resources 322. In these illustrative examples, cost 338 may be the cost for at least one of hardware 328, software 330, information technology labor 332, and other suitable costs for resources 322.

After cost 336 and cost 338 are calculated, a new network data processing system within number of new network data processing systems 316 is selected by evaluation process 314. For example, first new network data processing system 340 may be selected as one for analysis by evaluation process 314.

First new network data processing system 340 may take a number of different forms. For example, first new network data processing system 340 takes the form of cloud 342.

Evaluation process 314 identifies number of changes 344 in number of processes 320 when number of processes 320 is performed in cloud 342. For example, number of changes 344 may be a number of changes in labor 324. Number of changes 344 may take a number of different forms. For example, number of changes 344 may be at least one of a change in the number of the steps performed by number of processes 320, a change in the time needed to perform steps within number of processes 320, an ability to perform steps within number of processes 320 in parallel or perform processes within number of processes 320 in parallel, a change in personnel 326 performing labor 324, and other suitable changes to number of processes 320.

As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C, or item B and item C.

Number of changes 344 may also be a number of changes in resources 322 or a number of changes in information technology personnel 334 performing information technology labor 332.

First change in cost 346 and second change in cost 348 are identified by evaluation process 314. First change in cost 346 and second change in cost 348 are based on number of changes 344 in number of processes 320 when number of processes 320 is performed in cloud 342 instead of current network data processing system 308. First change in cost 346 is a change in cost 336 for labor 324. Second change in cost 348 is a change in cost 338 for resources 322 in cloud 342. Second change in cost 348 in cost 338 may be a change in the cost of hardware, the network, storage, power and cooling, maintenance, software, and/or other costs. In these examples, the changes may occur when moving from a network data processing system owned and maintained by an organization to a cloud.

When a change to current network data processing system 308 is made, a financial investment may be needed to purchase hardware, software, and/or other resources needed for making the change to current network data processing system 308. Further, additional personnel may need to be hired. First change in cost 346 and second change in cost 348 are determined by the return on the financial investment made to purchase the additional resources and/or personnel. The return on the financial investment is determined by overall cost savings, productivity gains, and faster times for making products available to the market.

With first change in cost 346 in cost 336 for number of processes 320 and second change in cost 348 in cost 338 for resources 322, return on investment 352 can be identified for upgrading current network data processing system 308 to cloud 342. Return on investment 352 is a metric in these examples. Return on investment 352 is a ratio of the amount of money gained or lost on an investment to the amount of money invested. Return on investment 352 is also referred to as profit, rate of return, or return.

Of course, other types of metrics may be used instead of return on investment 352. For example, the overall change in cost may be looked at without using ratios as in return on investment 352.

In these examples, return on investment 352 is part of result 318. Additionally, result 318 also may include recommendations 350 on whether to move organization 302 from current network data processing system 308 to cloud 342. Further, result 318 also may include a payback period. A payback period is a time needed to recover the initial investment when implementing or using a new network data processing system.

This type of process may be repeated for additional new network data processing systems within number of new network data processing systems 316 in addition to cloud 342. For example, second new network data processing system 356 may be selected for analysis by evaluation process 314.

In this illustrative example, second new network data processing system 356 takes the form of cloud 354. Cloud 342 is a different type of cloud from cloud 354. For example, cloud 342 may be a public cloud, while cloud 354 may be a private cloud or a hybrid cloud.

An analysis may be performed for second new network data processing system 356 similar to the analysis for first new network data processing system 340. The analysis for second new network data processing system 356 may have result 358 including return on investment 360 for cloud 358. In this manner, different network data processing systems may be analyzed to identify one that fits the needs and cost considerations for organization 302. Further, the analysis may identify the network data processing system that may provide the greatest benefits for organization 302 at a fixed cost.

In this manner, evaluation process 314 may be used by service provider 306 to provide consultant services to organization 302 in the selection of a new network data processing system for use to perform number of processes 320.

The illustration of network analysis environment 300 in FIG. 3 is not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, in some illustrative embodiments, evaluation process 314 may be used by organization 302 rather than through service provider 306. In some illustrative embodiments, evaluation process 314 may be automated and run by number of computers 312 without human interaction. For example, evaluation process 314 may be a web-based tool with a built-in interview process to automate the services provided by service provider 306. In still other illustrative embodiments, number of new network data processing systems 316 may use other types of network data processing systems other than clouds. For example, if current network data processing system 308 is a local area network, number of new network data processing systems 316 may include a wide area network.

As a result, the different illustrative embodiments are able to more accurately identify whether it is beneficial to move from one network data processing system to another network data processing system. Further, the different illustrative embodiments may be used to identify the best type of network data processing system to use. In these illustrative examples, the candidate network data processing systems are different types of cloud environments. Further, even within the same type of cloud environment, different types of services or configurations may be selected using the different illustrative embodiments.

The illustrative embodiments provide a capability to take into account changes in the manner in which processes performed by the organization used in a network data processing system change when moving from one type of network data processing system to another network data processing system. This change may result in one cloud being selected over another cloud, as opposed to only taking into account changes in the cost for resources by using a cloud. For example, the change to move from a local area network to a public cloud may have a greater change in cost savings with respect to resources for a network data processing system as compared to moving to a private cloud. However, by using a private cloud, increased security or separation may allow for elimination of steps that may be required using a public cloud. This elimination of steps in processes performed by the organization may result in a cost savings that is greater than the difference in the cost for resources.

With reference now to FIG. 4, a diagram of labor used to perform processes in a network data processing system is depicted in accordance with an illustrative embodiment. In this illustrative example, process 400 is an example of a process performed using a network data processing system. Process 400 may be a process within number of processes 320 in FIG. 3. As depicted, process 400 has steps 402, 404, 406, and 408. Of course, any number of steps may be present in process 400. Steps 402, 404, 406, and 408 are performed using labor from personnel assigned to perform these steps. Steps 402, 404, 406, and 408 may be, for example, without limitation, steps performed in software development. As a more specific example, the steps may be performed to approve a customer loan application.

As depicted, process 400 also includes steps 410, 412, and 414. These steps are steps performed using resources in the network data processing system. In particular, steps 410, 412, and 414 are performed using a resource in the network data processing system.

Steps 410, 412, and 414 are illustrations of steps performed using information technology labor provided by information technology personnel to enable and to manage hardware, software, and other resources needed to perform steps 402, 404, 406, and 408 in process 400.

When the network data processing system used for performing process 400 is switched from one network data processing system to another network data processing system, process 400 may change in a manner that reduces the cost of labor for process 400. For example, step 404 may no longer be necessary in process 400 when moving from one network data processing system to another network data processing system. By eliminating step 404, the cost of labor also may be reduced.

For example, step 404 may involve identifying a cause for a server error, and step 406 may involve rebooting the server. When moving to another network data processing system, step 404 may be eliminated. In other words, process 400 may reboot the server in step 406 without identifying the cause for the server error.

Further, in other illustrative examples, the interface between a step such as 402, 404, 406, or 408 of process 400 and a step such as 410, 412, or 414 performed to provide and manage hardware and software resources may be changed in a manner that reduces costs. For example, the interface may be changed from manual to automatic by using a programmatic interface. In yet other illustrative examples, some steps may now be performed parallel when moving from one type of network data processing system with limited information technology resources to another network data processing system where multiple information technology resources may be acquired and released on demand.

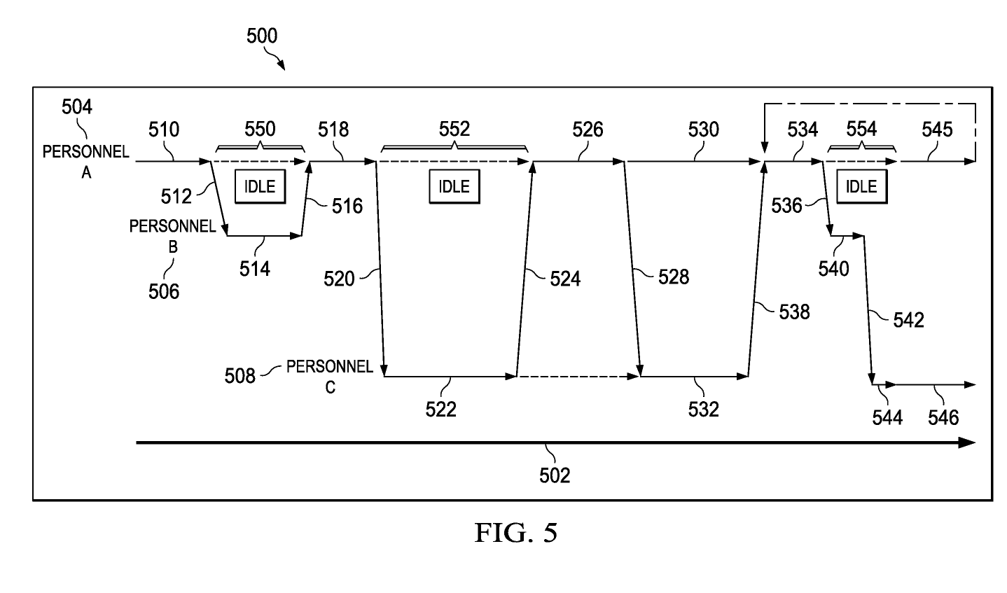

With reference now to FIG. 5, an illustration of a process performed using a current network data processing system is depicted in accordance with an illustrative embodiment. In this illustrative example, process 500 is an example of one implementation for a process in number of processes 320 in FIG. 3. Process 500 may be performed using a current network data processing system in this example. Further, process 500 is performed over time 502.

In this illustrative example, process 500 may be performed by personnel A 504, personnel B 506, and personnel C 508. Personnel A 504 performs a number of operations for performing process 500. Personnel B 506 provides the approval needed for different operations performed in personnel A 504. Personnel C 508 makes the resources needed available to personnel A 504 for performing the number of tasks for performing process 500. In this illustrative example, personnel C 508 is information technology personnel.

Personnel A 504 performs step 510 to generate a request to obtain the resources needed to perform process 500. Generating the request includes determining which resources are needed to perform process 500. These resources may include, for example, hardware, software, and/or other resources needed for process 500. Personnel A 504 performs step 512 to send the request for approval by personnel B 506.

As depicted, personnel B 506 performs step 514 to determine whether to approve the request to obtain the resources received from personnel A 504. This determination may be based on a number of factors including, for example, without limitation, a policy, a number of rules, business requirements of the organization performing process 500, a budget of the organization, and/or other suitable factors. Personnel B 506 performs step 516 to send approval of the request to obtain the resources to personnel A 504.

Personnel A 504 performs step 518 to prepare to obtain resources for performing process 500. This preparation includes at least one of setting up a number of server computers to receive at least a portion of the resources, setting up a number of accounts for information technology personnel providing at least a portion of the resources, configuring the current network data processing system to use the resources, and/or other operations.

Personnel A 504 performs step 520 to send the request to obtain the resources to personnel C 508. Personnel C 508 performs step 522 to fulfill the request for the resources received from personnel A 504. Personnel C 508 performs step 524 to make the resources available to personnel A 504 performing process 500. As depicted, personnel A 504 performs step 526 to configure the resources for use in performing process 500.

Personnel A 504 performs step 528 to alert personnel C 508 that the current network data processing system is ready to perform process 500. Personnel A 504 performs step 530 to perform the different tasks needed to perform process 500 using the resources. While personnel A 504 performs step 530, personnel C 508 performs step 532 to provide technical support and other information technology support for the resources provided by personnel C 508 being used by the current network data processing system to perform process 500.

When performing the different tasks for performing process 500, personnel A 504 may identify a number of changes that need to be made with respect to the resources being used by the current network data processing system. The number of changes may include, for example, without limitation, new resources being needed, some resources no longer being needed, upgrades needing to be made to the resources being used, maintenance needing to be performed, or other types of changes. When the number of changes is identified, personnel A 504 performs step 534 to generate a request for the number of changes to the resources needed to perform process 500. Personnel A 504 performs step 536 to send the request to personnel B 506 for approval by personnel B 506.

Further, when the number of changes is identified by personnel A 504, personnel C 508 may perform step 538 to stop support of the resources, while personnel A 504 generates the request for the number of changes to the resources.

As depicted, personnel B 506 performs step 540 to determine whether to approve the request for the number of changes to the resources needed for performing process 500. Once personnel B 506 determines to approve the request for the number of changes, personnel B 506 performs step 542 to send the request for the number of changes to the resources needed for performing process 500 to personnel C 508.

Personnel C 508 performs step 544 to fulfill the request for the number of changes to the resources. When the request has been fulfilled by personnel C 508, personnel A 504 continues performing the different tasks for performing process 500 in step 545. Further, as personnel A 504 performs step 544, personnel C 508 continues to provide support for the resources in step 546.

In this illustrative example, at least a portion of the different steps depicted for performing process 500 may be repeated a number of times, depending on the implementation. For example, while personnel A 504 performs step 544 and personnel C 508 performs step 546, personnel A 504 may identify a new number of changes for the resources. Personnel A 504 may then perform step 534 again to generate a request for a new number of changes. Thereafter, the steps following step 534 may be performed. Further, process 500 may be one in a number of processes for completing a project.

In this illustrative example, idle time 550, idle time 552, and idle time 554 are the times during which personnel A 504 are not performing steps to perform process 500. Idle time 550, idle time 552, and idle time 554 are the times during which personnel A 504 must wait for personnel B 506 and/or personnel C 508 to perform steps before personnel A 504 can perform steps.

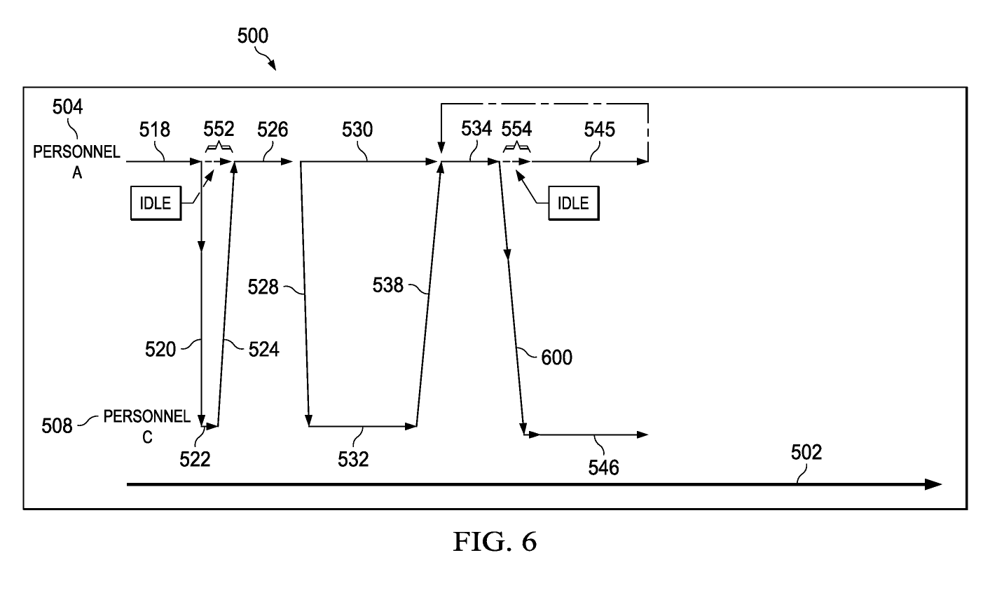

With reference now to FIG. 6, an illustration of a process performed using a new network data processing system is depicted in accordance with an illustrative embodiment. In this illustrative example, process 500 in FIG. 5 is performed by a new network data processing system. The new network data processing system, in this illustrative example, is different from the current network data processing system performing process 500 in FIG. 5. Further, the network data processing system in this depicted example takes the form of a cloud network data processing system.

With a cloud network data processing system, the time needed to perform process 500 may be reduced by standardization and automation of at least a portion of the steps needed to perform process 500. Further, a greater number of resources are provided by the cloud network data processing system as compared to the current network data processing system. These resources are standardized and may be pre-approved for use.

As one example, the reduction in time for performing process 500 is provided by the elimination of steps and personnel needed to perform process 500. As a specific example, personnel B 506 is no longer needed to provide approval for different operations in process 500. Personnel A 504 may perform step 520 to send the request to obtain resources directly to personnel C 508 without requiring approval from personnel B 506. Approval for the request is automated in this example. In this manner, steps 510, 512, 514, and 516 may be eliminated in this illustrative example.

Still further, with the cloud network data processing system, the time needed to perform step 522 by personnel C 508 may be reduced. Less time may be needed for step 522, because the resources provided by the cloud network data processing system are standardized and automated. Further, less time may be needed for step 522, because the resources may be built or obtained prior to receiving the request in anticipation of the request. The resources may be built or obtained ahead of time, because they are standardized and pre-approved. In this manner, less time is needed to fulfill the request for the resources.

In this illustrative example, step 536 performed by personnel A 504, step 540 performed by personnel B 506, and step 542 performed by personnel B 506 in FIG. 5 are replaced by step 600 performed by personnel A 504. The request for the number of changes to the resources may be sent directly from personnel A 504 to personnel C 508 in step 600 performed by personnel A 504.

As depicted, less idle time is spent performing process 500 using the cloud network data processing system as compared to performing process 500 using the current network data processing system in FIG. 5. Idle time 552 and idle time 554 are reduced in this illustrative example as compared to idle time 552 and idle time 554 in FIG. 5. Further, idle time 550 is no longer present when using the cloud network data processing system.

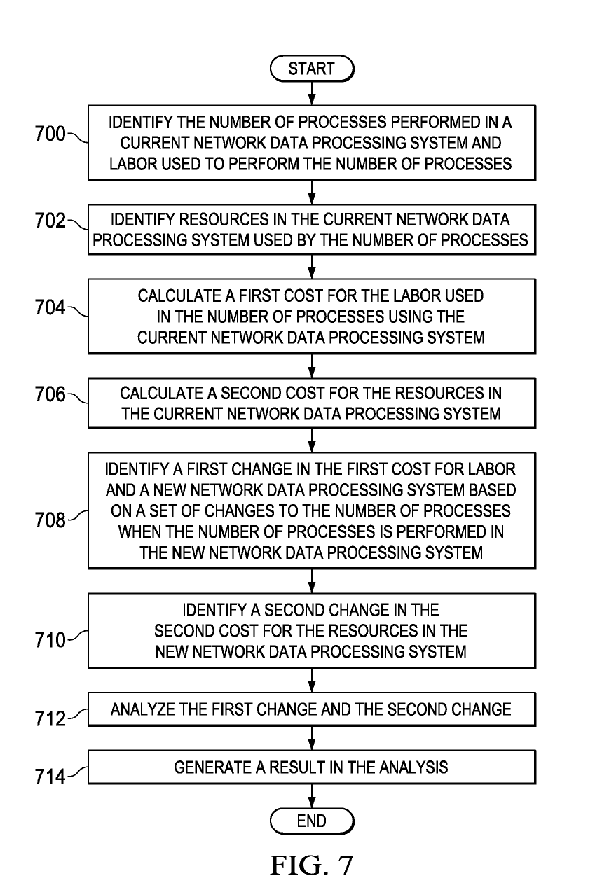

With reference now to FIG. 7, a flowchart of a process for planning changes to network data processing systems is depicted in accordance with an illustrative embodiment. The flowchart in FIG. 7 may be implemented in evaluation process 314 in FIG. 3. In these examples, this process may be implemented as program code that is run by a processor unit.

The process begins by identifying the number of processes performed in a current network data processing system and labor used to perform the number of processes (step 700). The process then identifies resources in the current network data processing system used by the number of processes (step 702). The process then calculates a first cost for the labor used in the number of processes using the current network data processing system (step 704). The process calculates a second cost for the resources in the current network data processing system (step 706).

A first change is identified in the first cost for labor and a new network data processing system based on a set of changes to the number of processes when the number of processes is performed using the new network data processing system (step 708). A second change in the second cost for the resources in the new network data processing system is also identified (step 710).

An analysis of the first change and the second change is made (step 712). A result is generated in the analysis (step 714), with the process terminating thereafter. With the result, a determination may be made as to whether to use the new network data processing system based on the first change in the first cost for labor in the new network data processing system and the second change in the second cost for the resources in the new network data processing system.

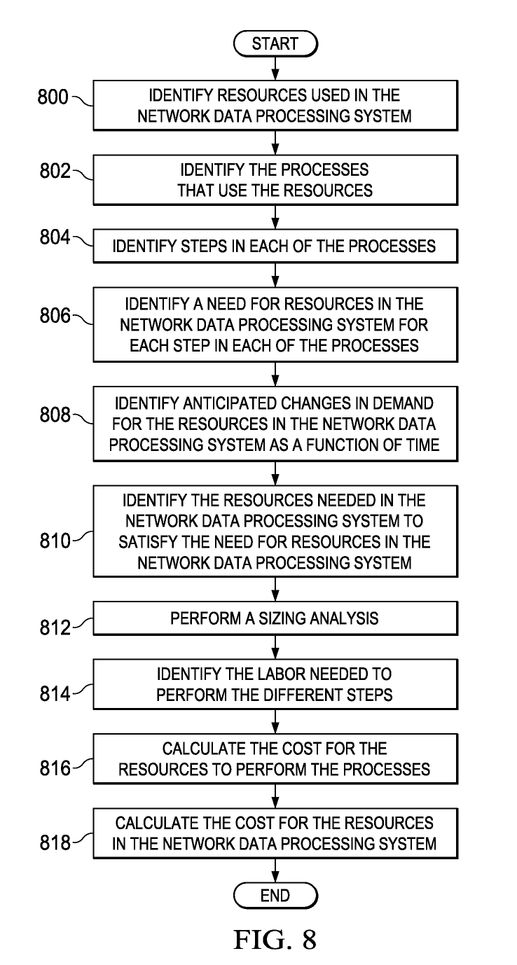

With reference now to FIG. 8, an illustration of cost estimation is depicted in accordance with an illustrative embodiment. The process illustrated in FIG. 8 may be implemented in evaluation process 314 in FIG. 3. The process illustrated in FIG. 8 may be implemented as program code run by a processor unit. This process may be used to identify costs in steps 504 and 506 in FIG. 5. This process also may be used to identify changes to costs in steps 500 and 510. For example, the costs in the new network data processing system may be calculated and then compared to the costs in the network data processing system to identify the changes in cost.

The process begins by identifying resources used in the network data processing system (step 800). This step may be performed by interviewing subject matter experts regarding the various information technology functions, processes, and steps in the information technology processes. Further, step 800 also may identify hardware and software used in the network data processing system. The information obtained from subject matter experts may be entered for use in step 800. The process then identifies the processes that use the resources (step 802). For example, if the process is a software test project, the different steps may include identifying tests for software needed, obtaining approval for the project, obtaining approval for the resources, obtaining resources, installing the software, and testing the software.

The process then identifies steps in each of the processes (step 804). Thereafter, resources needed in the network data processing system are identified for each step in each of the processes (step 806). In these examples, the resources are the labor performed by information technology personnel, hardware, software, and other suitable types of resources present in a network data processing system. The process then identifies anticipated changes in demand for the resources in the network data processing system as a function of time (step 808).

In step 808, anticipated changes may be identified by performing calculations using the current demand. For example, one method for identifying the anticipated changes in demand involves performing a linear extrapolation of the current demand. In other words, the demand is modeled to increase by a specified amount linearly over time. This specified amount may be, for example, about five percent every quarter.

The process then identifies the resources needed in the network data processing system to satisfy the need for resources in the network data processing system (step 810). In step 808, the process takes into account the anticipated changes and demand for the resources. The process then performs a sizing analysis (step 812). In step 812, the process identifies the specific number and type of resources needed to satisfy the need for resources in the network data processing system. For example, the process may identify a specific number of server computers of a certain type and a specific number of storage devices of a certain type. The type may include, for example, a model number, a central processing unit rating, and an amount of memory.

The process then identifies the labor needed to perform the different steps (step 814). The labor identified in step 814 includes both the labor to perform the processes, as well as the labor involved in the information technology side to provide hardware and software resources.

The cost for the resources to perform the processes is calculated (step 816). The cost for the resources and labor performed by information technology personnel in the network data processing system are also calculated (step 818), with the process terminating thereafter.

The result of this process is a cost for the network being analyzed. This process may be performed for different types of analysis to obtain differences in cost between the different types of networks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

For example, some of the steps in FIG. 6 may be performed in parallel or in different orders. As one example, step 616 and step 618 may be performed at the same time. In some examples, step 618 may be performed before step 616.

As another example, step 614 may be performed before step 612. With this order of steps, the sizing analysis performed in step 612 may also involve identifying a specific number of personnel to perform the needed labor.

The different illustrative embodiments allow an analysis of the changes in cost for switching from one network data processing system to another network data processing system to be performed for the overall processes implemented in the network data processing system. The new network data processing system may be implemented as a cloud. A cloud is a type of information technology service that can be obtained on the Internet. By using a cloud for the new network data processing system, increased resources may be provided for the processes implemented on the cloud. Further, a cloud has a lower cost and requires a lesser investment as compared to other types of network data processing systems.

The different illustrative embodiments take into account the changes in overall cost based on the different changes in the processes implemented in the network data processing systems from switching to another network data processing system. These changes include changes to the steps performed in the processes, changes in labor, changes in the resources needed, and other changes.

In this manner, the different illustrative embodiments provide a method and apparatus to plan changes to network data processing systems. With one or more of the different illustrative embodiments, costs and benefit tradeoffs can be more accurately identified. The different illustrative embodiments take into account that changes may occur in the manner in which processes are performed when changes occur in the type of network data processing system used. These changes in the manner in which processes are performed result in changes in the cost to perform those processes for an organization. As a result, these changes in cost may be taken into account with the change in cost for a network data processing system.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment, or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer usable or computer readable medium providing program code for use by or in connection with a computer or any instruction system. For the purposes of this description, a computer usable or computer readable medium can be any tangible apparatus that can contain, store, communicate, propagate, or transport the program for use by or in connection with the instruction system, apparatus, or device.

The medium can be an electronic, magnetic, optical, electromagnetic, infrared, or semiconductor system (or apparatus or device), or a propagation medium. Examples of a computer readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual running of the program code, bulk storage, and cache memories, which provide temporary storage of at least some program code in order to reduce the number of times code must be retrieved from bulk storage during running of the code.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems, remote printers, or storage devices through intervening private or public networks. Modems, cable modem, and Ethernet cards are just a few of the currently available types of network adapters.

The description of the present invention has been presented for purposes of illustration and description and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for planning changes to network data processing systems, the method comprising;
identifying a number of processes performed in a current network data processing system and labor used to perform the number of processes;
identifying resources in the current network data processing system used by the number of processes;
calculating a first cost for the labor used to perform the number of processes using the current network data processing system;
calculating a second cost for the resources in the current network data processing system;
identifying a first change in the first cost for the labor in a new network data processing system based on a number of changes to the number of processes when the number of the processes is performed in the new network data processing system; and
identifying a second change in the second cost for the resources in the new network data processing system.

2. The method of claim 1 further comprising:
determining whether to use the new network data processing system based on the first change in the first cost for the labor in the new network data processing system based on the number of changes to the number of processes when the number of processes are performed in the new network data processing system and the second change in the second cost for the resources in the new network data processing system.

3. The method of claim 1, wherein the step of identifying the first change in the first cost for the labor in the new network data processing system based on the number of changes to the number of processes and the resources when the number of processes are performed in the new network data processing system comprises:
identifying a change in the number of processes in which the change is caused by the number of processes being performed in a second network data processing system; and
identifying the first change in the first cost for the labor in the new network data processing system based on the change in the number or processes in which the change is caused by the number of processes being performed in the second network data processing system.

4. The method of claim 1, wherein the labor is first labor, and the step of identifying the second change in the second cost for the resources in the new network data processing system comprises:
identifying a change in second labor in the resources in the new network data processing system.

5. The method of claim 4, wherein the first labor uses the second labor in the resources to perform the number of processes.

6. The method of claim 5, wherein the change in the second labor causes a change in the number of processes resulting in a change in the first labor.

7. The method of claim 5, wherein the second labor is performed using information technology personnel.

8. The method of claim 1, wherein the new network data processing system is a first new network data processing system and further comprising:
selecting a second new network data processing system if the first change in the first cost and the second change in the second cost is not a reduction in the first cost and in the second cost;
identifying the first change in the first cost for the labor in the second new network data processing system based on a change to the number of processes and the resources when the number of processes is performed in the second new network data processing system; and
identifying the second change in the second cost for the resources in the second new network data processing system.

9. The method of claim 1, wherein the new network data processing system is selected from one of a public cloud, a private cloud, and a hybrid cloud.

10. A computer comprising:
a bus system;
a number of storage devices connected to the bus system, wherein program code is located on the number of storage devices;
a processor unit connected to the bus system, wherein the processor unit is configured to run the program code to identify a number of processes performed in a current network data processing system and labor used to perform the number of processes; identify resources in the current network data processing system used by the number of processes; calculate a first cost for the labor used to perform the number of processes using the current network data processing system; calculate a second cost for the resources in the current network data processing system; identify a first change in the first cost for the labor in a new network data processing system based on a number of changes to the number of processes when the number of processes are performed in the new network data processing system; and identify a second change in the second cost for the resources in the new network data processing system.

11. The computer of claim 10, wherein the processor unit runs the program code to determine whether to use the new network data processing system based on the first change in the first cost for the labor in the new network data processing system based on the number of changes to the number of processes when the number of processes are performed in the new network data processing system and the second change in the second cost for the resources in the new network data processing system.

12. The computer of claim 10, wherein in identifying the first change in the first cost for the labor in the new network data processing system based on the number of changes to the number of processes and the resources when the number of processes are performed in the new network data processing system, the processor unit runs the program code to identify a change in the number of processes in which the change is caused by the number of processes being performed in a second network data processing system; and identify the first change in the first cost for the labor in the new network data processing system based on the change in the number of processes in which the change is caused by the number of processes being performed in the second network data processing system.

13. The computer of claim 10, wherein the labor is first labor and wherein in identifying the second change in the second cost for the resources in the new network data processing system, the processor unit runs the program code to identify a change in second labor in the resources in the new network data processing system.

14. The computer of claim 13, wherein the first labor uses the second labor in the resources to perform the number of processes.

15. The computer of claim 14, wherein the change in the second labor causes a change in the number of processes resulting in a change in the first labor.

16. The computer of claim 14, wherein the second labor is performed using information technology personnel.

17. The computer of claim 10, wherein the new network data processing system is a first new network data processing system and wherein the processor unit runs the program code selecting a second new network data processing system if the first change in the first cost and the second change in the second cost is not a reduction in the first cost and in the second cost; identify the first change in the first cost for the labor in the second new network data processing system based on a change to the number of processes and the resources when the number of processes is performed in the second new network data processing system; and identify the second change in the second cost for the resources in the second new network data processing system.

18. The computer of claim 10, wherein the new network data processing system is selected from one of a public cloud, a private cloud, and a hybrid cloud.

19. A computer program product comprising:
a computer recordable storage medium;
program code, stored on the computer recordable storage medium, for identifying a number of processes performed in a current network data processing system and labor used to perform the number of processes;
program code, stored on the computer recordable storage medium, for identifying resources in the current network data processing system used by the number of processes;
program code, stored on the computer recordable storage medium, for calculating a first cost for the labor used to perform the number of processes using the current network data processing system;
program code, stored on the computer recordable storage medium, for calculating a second cost for the resources in the current network data processing system;
program code, stored on the computer recordable storage medium, for identifying a first change in the first cost for the labor in a new network data processing system based on a number of changes to the number of processes when the number of processes is performed in the new network data processing system; and
program code, stored on the computer recordable storage medium, for identifying a second change in the second cost for the resources in the new network data processing system.

20. The computer program product of claim 19 further comprising:
program code, stored on the computer recordable storage medium, for determining whether to use the new network data processing system based on the first change in the first cost for the labor in the new network data processing system based on the number of changes to the number of processes when the number of processes is performed in the new network data processing system and the second change in the second cost for the resources in the new network data processing system.

21. The computer program product of claim 19, wherein the program code, stored on the computer recordable storage medium, for identifying the first change in the first cost for the labor in the new network data processing system based on the number of changes to the number of processes and the resources when the number of processes is performed in the new network data processing system comprises:
program code, stored on the computer recordable storage medium, for identifying a change in the number of processes in which the change is caused by the number of processes being performed in a second network data processing system; and
program code, stored on the computer recordable storage medium, for identifying the first change in the first cost for the labor in the new network data processing system based on the change in the number of processes in which the change is caused by the number of processes being performed in the second network data processing system.

22. The computer program product of claim 19, wherein the labor is first labor, and the program code, stored on the computer recordable storage medium, for identifying the second change in the second cost for the resources in the new network data processing system comprises:
program code, stored on the computer recordable storage medium, for identifying a change in second labor in the resources in the new network data processing system.
